(19) United States
(12) Patent Application Publication
(10) Pub. No.: US 2017/0024715 A1
(43) Pub. Date: Jan. 26, 2017

(54) SYSTEMS & METHODS FOR MAKING REAL-TIME ELECTRONIC PAYMENTS USING A GRAPHICAL USER INTERFACE

(71) Applicant: Value Payment Systems, LLC, Nashville, TN (US)

(72) Inventors: Jeffrey GARDNER, Columbia, TN (US); Jeffrey Scott Slusser, Nashville, TN (US)

(73) Assignee: Value Payment Systems, LLC, Nashville, TN (US)

(21) Appl. No.: 15/288,490

(22) Filed: Oct. 7, 2016

Related U.S. Application Data
(63) Continuation-in-part of application No. 13/160,918, filed on Jun. 15, 2011, now abandoned.

(51) Int. Cl. G06Q 20/10; G06Q 20/40

(52) U.S. Cl. CPC G06Q 20/102; G06Q 20/405

(57) ABSTRACT

A graphical user interface, systems, and methods of using an intermediary computer to process payments in real-time. Tax payments are processed over a secure network directly to a government authority without being coupled with electronic filing of tax returns or other filing or processing documents.

### CROSS REFERENCE TO RELATED APPLICATIONS

This application is related to and claims priority from the following U.S. patent applications: it is a continuation-in-part of U.S. patent application Ser. No. 13/160,918, filed Jun. 15, 2011, which is incorporated herein by reference in its entirety.

### BACKGROUND OF THE INVENTION

1. Field of the Invention

The present invention relates generally to electronic financial transactions, and more particularly to systems and methods for electronic payment transactions for making real-time electronic payments to payees including government authorities, retailers, and individuals using a graphical user interface (GUI) from a location remote to the payee.

2. Description of the Prior Art

Generally, it is known in the art to conduct financial transactions using a network-based system for transmitting and receiving electronic payments. By way of example, it is known to make electronic payments over a network such as the Internet by transactions involving payments from individuals' and business' credit, debit, prepaid, ATM card, PayPal account, Bill Me Later account, or other electronic payment methods (“Electronic Payment”) for various types of payment transactions.

More specifically, concerning government-related transactions, particularly in the US, most systems do not provide for individual payments to be made using credit cards or other electronic payment methods, such as emerging electronic payment methods for making payments through non-traditional third parties other than banks, credit cards, etc., even though they are commonly used in online commerce for making payments for everything from services to goods. While it is known in the art to use point-of-sale (POS) devices for making payments with credit cards, debit cards, or electronic funds transfer (EFT) for various transactions, these documents do not provide POS devices for making payments of taxes, for example to the federal government in the United States. Furthermore, it is known in the art to provide payment of taxes through a website over the internet or computer-downloadable software using EFT payment or credit card payment, they do not provide for a standalone device or system.

Also, and by way of related example, presently, the US Internal Revenue Service (IRS) and other state income tax departments allow individuals to make electronic payments using their credit cards and debit cards (“Cards”) through various third party organizations. These third party organizations collect funds from a number of individuals by electronically charging their Cards. The organizations then make lump sum, bulk, pooled, or batch payments to the taxing authority, based on a separate payment file or multiple files, for all individuals paying within a specific time period using the third party's own bank accounts.

Examples of some relevant art documents that describe income tax preparation kiosks that receive and process user data and allow the user to pay at the kiosk with cash, credit or debit cards include the following:

US Pub. No. 20050038722 for “Methods, systems, and computer program products for processing and/or preparing a tax return and initiating certain financial transactions” by Throndson, filed Mar. 29, 2004, describes that a tax return is processed by receiving tax information associated with a taxpayer where the tax information is in a plurality of formats. The tax information is converted into a common electronic format. A determination is made whether the tax information is sufficient to generate a tax return therefrom. A tax return is generated if the tax information has been determined to be sufficient.

US Pub. No. 20020013747 for “Method and apparatus for electronic filing of income tax returns by a taxpayer” by Valentine, filed Feb. 22, 2011, describes a unique business process system that looks like a free-standing ATM, internet access kiosk, video game, or check cashing kiosk. The present invention is a self-service tax preparation and electronic filing (e*file) device for Federal and State income tax returns. The Present invention allows consumers without access to a computer, the internet, a major credit card or a bank account to take advantage of electronic filing, direct deposit, refund anticipation loans (RAL), refund anticipation cashier's checks (RAC), and refund transfers (RT) without having to hire and pay a human tax preparer. The present invention will be placed in public locations, such as discount stores, grocery stores, postal service stores, malls, colleges and universities, and other retail or public locations. While using existing hardware and software that are in the public domain, the present invention's unique business process eliminates the need to pay live preparer fees, allows all taxpayers to access electronic filing and bank products, and reduces fee loads for lower income taxpayers while still allowing them access to now unavailable products such as e*file and RAL. The present invention is novel and unobvious in that all tax preparation has previously required either self preparation on paper, visiting a paid preparer, or owning a computer with access to the internet. It is useful in that it greatly expands access to e*filing and bank products (RAL, RAC, RT) and sharply reduces consumer costs for using these services.

US Pub. No. 20060010050 for “Income tax preparation kiosk” by Dowdell, filed Jun. 29, 2004, describes an Income Tax Preparation Kiosk will allow for a more intimate setting with clients of heavier workloads for any income tax preparer/accountant. Much of the RAL clients' income tax preparation is automated and depends on the efficiency of the preparer. This kiosk will minimize the time spent on returns that are due 100% and more earned income credit. This will provide more quality time for the more involved client. Leaving the more simple, income tax preparation, tasks to the kiosk will allow for less waiting and more precise preparation of more involved clients. Reducing the number of audits and easing the pinch on taxpayers.

Further claims presenting the taxpayer with options for paying the tax comprises: filing the tax return electronically; and paying the tax via cash, credit/debit card, and/or an electronic transfer of funds.

U.S. Pub. No. 2008/0097878 for “System and method for payment of estimated tax due” by Abeles, filed Jan. 14, 2007, describes that embodiments of the present invention may provide a method and system for accepting financial information from a customer for generating an estimated tax due to the taxing authority and a date by which the estimated tax is due, and periodically impounding an amount of money from an account held by the customer, where each amount impounded is less than the estimated tax and the combined value of the amounts impounded by the date substantially match the estimated tax.

U.S. Pub. No 2002/0013747 for “Method and apparatus for electronic filing of income tax returns by a taxpayer” by Valentine filed Feb. 22, 2001, describes a unique business process system that looks like a free-standing ATM, internet access kiosk, video game, or check cashing kiosk. The present invention is a self-service tax preparation and electronic filing (e*file) device for Federal and State income tax returns. The Present invention allows consumers without access to a computer, the internet, a major credit card or a bank account to take advantage of electronic filing, direct deposit, refund anticipation loans (RAL), refund anticipation cashier's checks (RAC), and refund transfers (RT) without having to hire and pay a human tax preparer. The present invention will be placed in public locations, such as discount stores, grocery stores, postal service stores, malls, colleges and universities, and other retail or public locations. While using existing hardware and software that are in the public domain, the present invention's unique business process eliminates the need to pay live preparer fees, allows all taxpayers to access electronic filing and bank products, and reduces fee loads for lower income taxpayers while still allowing them access to now unavailable products such as e*file and RAL. The present invention is novel and unobvious in that all tax preparation has previously required either self preparation on paper, visiting a paid preparer, or owning a computer with access to the internet. It is useful in that it greatly expands access to e*filing and bank products (RAL, RAC, RT) and sharply reduces consumer costs for using these services.

U.S. Pat. No. 6,202,052 for “Fully-automated for tax reporting, payment and refund” by Miller, filed May 7, 1998 and issued Mar. 13, 2001, describes an electronic intermediary electronically connects with a tax data provider and collects electronically tax data from the tax data provider. The electronic intermediary processes the tax data collected electronically, and prepares an electronic tax return using the processed tax data. The electronic intermediary connects electronically with a taxing authority, files the electronic tax return with the taxing authority, and arranges electronically for the payment or receipt of any tax liability or refund, respectively.

U.S. Pat. No. 6,697,787 for “System for collecting tax data” by Miller, filed Feb. 6, 2001 and issued Feb. 24, 2004, describes an electronic intermediary electronically connects with a tax data provider and collects electronically tax data from the tax data provider. The electronic intermediary processes the tax data collected electronically, and prepares an electronic tax return using the processed tax data.

U.S. Pub. No 2001/0037268 for “Fully-automated system for tax reporting, payment and refund and system for accessing tax information” by Miller, filed Mar. 12, 2001, describes a tax information requestor collects tax information. The tax information requestor connects electronically to an electronic intermediary and/or to a tax data provider. The tax information requestor collects electronically an electronic tax return and/or tax data of a taxpayer from the electronic intermediary. The tax information requestor collects electronically tax data from the tax data provider. A tax information distributor collects tax information. The tax information distributor connects electronically to electronic intermediaries and/or to tax data providers. The tax information distributor collects electronically electronic tax returns and/or tax data of taxpayers from the electronic intermediaries. The tax information distributor collects electronically tax data of taxpayers from the tax data providers. The tax information distributor assembles collected electronic tax returns and/or tax data to obtain assembled tax information of taxpayers.

### SUMMARY OF THE INVENTION

The present invention is directed to methods for processing payments electronically over a network-based system, such as Internet, phone, wireless communications, and other channels, wherein a third party or intermediary facilitates payment transactions in order to simplify and enable the processing of payments on behalf of individuals through all types of electronic, network-based payment methods without requiring payment integration by the payment recipient.

One aspect of the present invention provides a method for processing payments electronically over a network-based system including the steps of:

(a) providing a dedicated device for making payments directly to a government entity for receiving and remitting payments from individuals;
(b) initiating a transaction for making a payment on behalf of an individual;
(b) receiving electronic payment information or data and corresponding authorization for a government tax payment from an individual account, such as a credit card or debit card; and
(c) providing the electronic payment data directly to the government for immediate credit of the tax payment by the individual, without transmission or submission of any tax filing documentation at the time of the payment.

Significantly, the tax payment does not correspond to a tax filing component or data; rather, it is simply providing a direct payment to the government for tax or other government fees due by an individual via a freestanding, dedicated device.

A second aspect of the present invention is to provide systems and methods for making individualized electronic payments directly to government entities or agencies, such as the IRS, state tax departments or other government agency through a dedicated freestanding device that preferably is integrated with the government payment system(s) providing immediate credit for the payment by the individual without the requiring or including any tax filing documents. In one embodiment, an individual enters his/her unique taxpayer identification number, such as but not limited to social security number or other government-assigned taxpayer identification, and provide a credit card or debit card and its corresponding information for making an electronic payment via the dedicated device for receipt directly by the government.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a PRIOR ART flow diagram illustrating steps for making a payment to a government entity by an individual.

FIG. 2 is a flow diagram illustrating steps for making electronic payments by an individual directly to the government via a dedicated device, according to one embodiment of the present invention.

FIG. 3 is a PRIOR ART flow diagram.

FIG. 4A and FIG. 4B form a continuous (connected) flow diagram of PRIOR ART methods for credit card integrated file and bulk payment to payment recipient for an IRS example.

FIG. 5 is a schematic diagram showing a multiplicity of dedicated devices and networked connection for making the payments directly to the government by individuals and/or taxpayer entities represented by individuals using the devices.

FIG. 6 is a screenshot of a graphical user interface (GUI) presented to a payor for entering information for making a payment to a payee via an intermediary.

FIG. 7 is a screenshot of a graphical user interface (GUI) presented to a payor for reviewing information entered for making a payment to a payee via an intermediary.

FIG. 8 is a screenshot of a graphical user interface (GUI) presented to a payor detailing the payment receipt for a payment made to a payee via an intermediary.

FIG. 9 is a schematic diagram of an embodiment of the invention illustrating a computer system used in accordance with systems and methods of the present invention.

### DETAILED DESCRIPTION

The term “payment” or “payments” as used hereinbelow in the detailed description of the invention and preferred embodiments is defined as a financial transaction that may either be a debiting from an account or a transfer initiated from that account.

Referring now to the drawings in general, the illustrations are for the purpose of describing a preferred embodiment of the invention and are not intended to limit the invention thereto. The present invention provides methods of electronically processing individual income tax payments from a remote location to the government tax payment authority.

Furthermore, it is known in the art to provide payment of taxes through a website over the internet or computer-downloadable software using EFT payment or credit card payment, they do not provide for a standalone device or system that is dedicated for making tax payments to a government authority as provided by the present invention with a kiosk or other standalone, dedicated device that is not coupled with preparation and filing of tax returns, tax forms, or other documentation associated with taxes.

Since the prior art set forth in the foregoing does not provide the solutions that continue to exist as a longstanding and unmet need, there remains a need for a system and methods for processing payments electronically from a remote location to simplify and enable the processing of payments only where individual users would not otherwise be able to participate or complete the transaction directly with the government entity, or where individual payments made through an electronic kiosk-type system or device would simplify the processing and extend the electronic payment options, separate and apart from filing any forms or tax documents. There also remains a need for facilitate individualized Electronic Payments to be made to government entities, such as the IRS, state tax departments remotely and without being coupled to tax filing documents.

The present invention is also related to U.S. patent application Ser. No. 13/842,802, filed Mar. 15, 2013, and U.S. patent application Ser. No. 15/269,271, filed Sep. 19, 2016, which describe systems and methods of determining convenience fees. U.S. patent application Ser. No. 13/842,802 and U.S. patent application Ser. No. 15/269,271 are incorporated herein by reference in their entirety.

The present invention provides a method for processing payments electronically over a network-based system including the steps of:

(a) providing a dedicated device for making payments directly to a government entity for receiving and remitting payments from individuals;
(b) initiating a transaction for making a payment on behalf of an individual;
(b) receiving electronic payment information or data and corresponding authorization for a government tax payment from an individual account, such as a credit card or debit card; and
(c) providing the electronic payment data directly to the government for immediate credit of the tax payment by the individual, without transmission or submission of any tax filing documentation at the time of the payment.

Significantly, a direct tax payment made using the dedicated device and methods of using same according to the present invention does not require and does not correspond to a tax filing component or data submitted therewith; rather, the direct payment to the government for tax or other government fees due by an individual via a freestanding, dedicated device includes submission of an electronic payment by an individual or corporate entity identified by and associated with a unique taxpayer identification.

Additionally, the present invention provides systems and methods for making individualized electronic payments directly to government entities or agencies, such as the IRS, state tax departments or other government agency through a dedicated freestanding device that preferably is integrated with the government payment system(s) providing immediate credit for the payment by the individual without the requiring or including any tax filing documents. In one embodiment, an individual enters his/her unique taxpayer identification number, such as but not limited to social security number or other government-assigned taxpayer identification, and provide a credit card or debit card and its corresponding information for making an electronic payment via the dedicated device for receipt directly by the government.

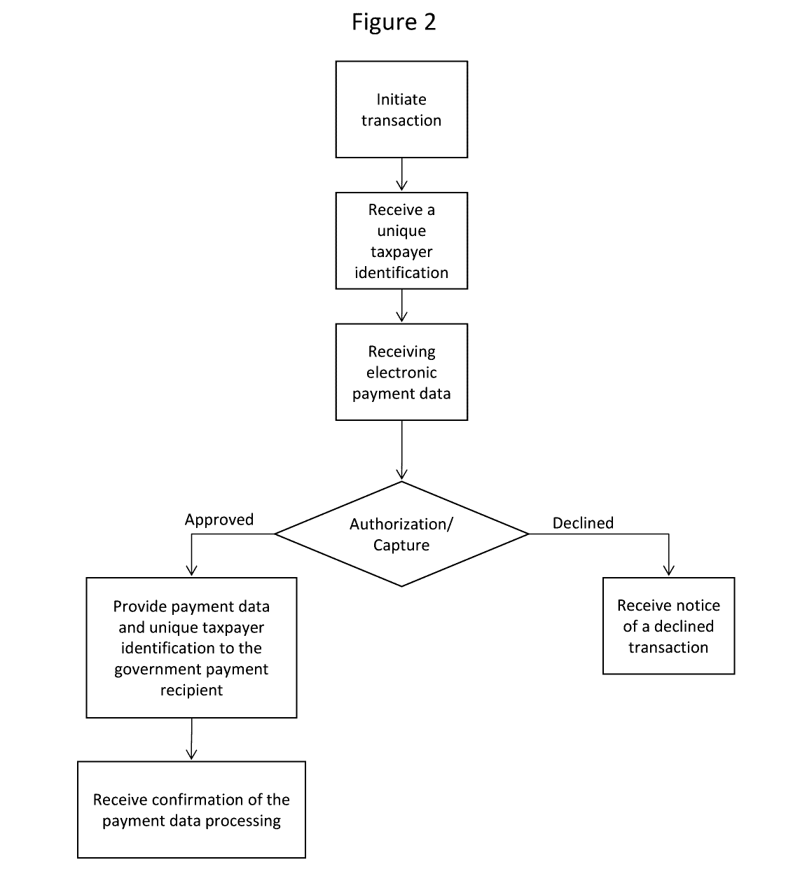

More specifically, as illustrated by the flow diagram of FIG. 2, the present invention provides a method for making electronic financial transactions for payments to government entities or agencies directly including the steps of: providing a network for making electronic data communications, including secure transmission of payment data for transmitting payments between a dedicated device, such as but not limited to a point of sale (POS) payment device and a government payment recipient, without including any tax filing or other tax documentation therewith; initiating a transaction over the network via the dedicated payment device for making an electronic payment on behalf of an individual taxpayer or taxpaying entity owing the government entity a tax payment or fee; the dedicated device operable for receiving authorization and data for electronic payment by the taxpayer; receiving a unique taxpayer identification; providing payment data and unique taxpayer identification to the government payment recipient relating to the tax payment made directly and without submission of corresponding tax documents for making a tax filing. Optionally, an additional step of receiving confirmation of the payment data processing by the payment recipient may be included, confirming the immediate credit of the payment to the taxes and/or fees owed to the government by the taxpayer. Alternatively, and also optionally, an additional step of receiving notice of a declined transaction is provided.

Notably, the point of sale device includes a point of sale device including a card reader, a chip reader, or a radio frequency reader. Payments are made by the payor via a smart card, a mobile payment application on a mobile device, or through any other method using NFC or RF communications.

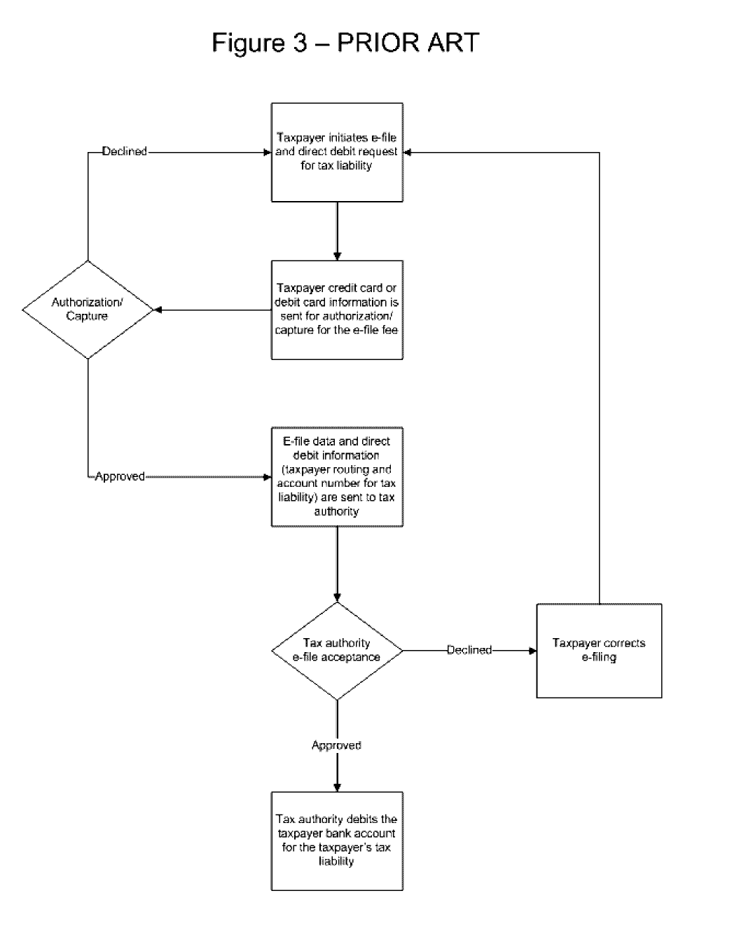

FIG. 3 is a PRIOR ART flow diagram illustrating a tax liability bank account direct debit (not credit card) process wherein the individual payor account information is provided to the payment recipient for a tax payment example.

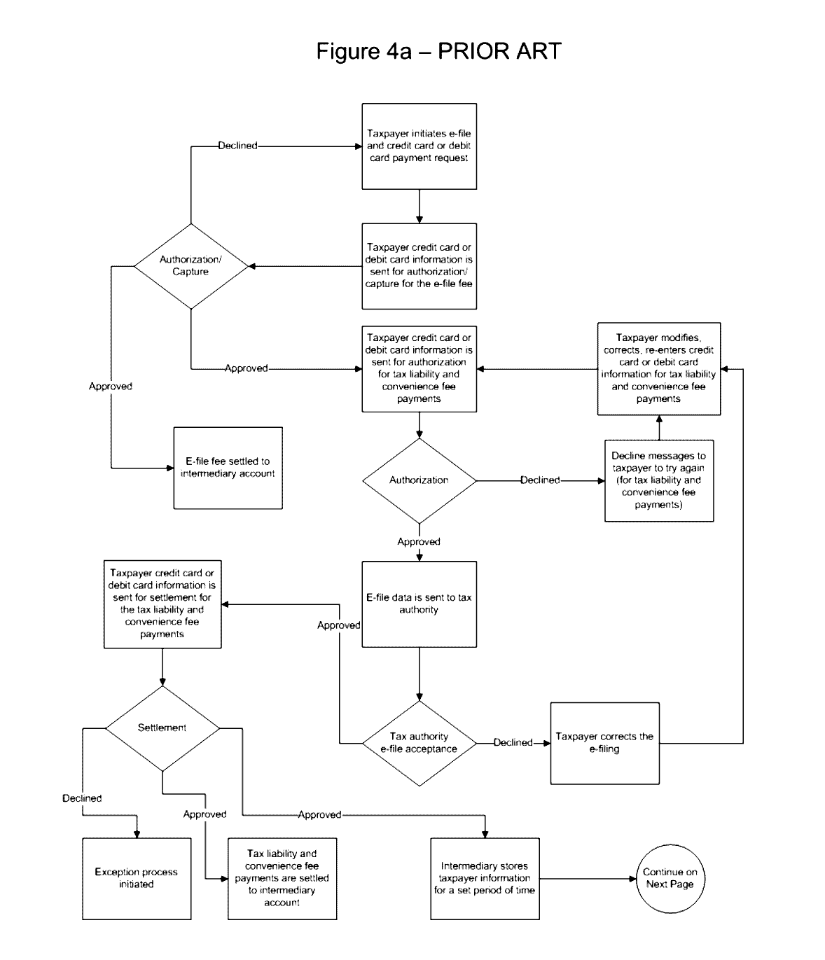

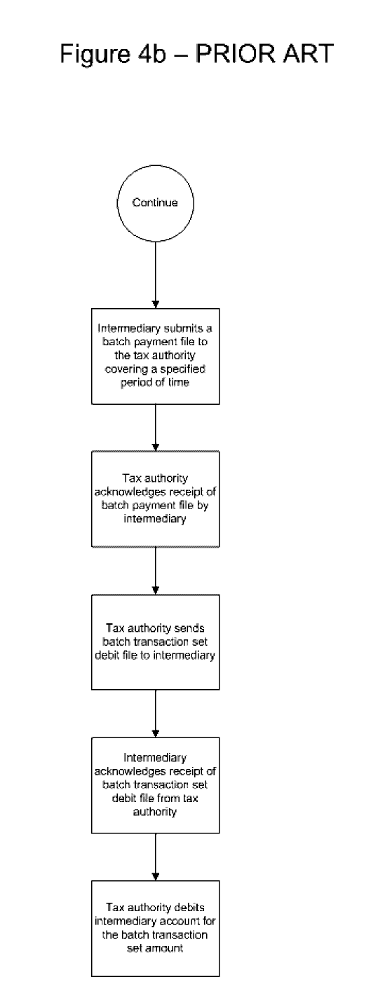

FIG. 4A and FIG. 4B form a continuous (connected) flow diagram of PRIOR ART methods for credit card integrated file and bulk payment to payment recipient for an IRS example. In this extended flow diagram, a credit card integrated file and bulk payment filer process is illustrated, including the individual payor (taxpayer) provides his/her own individual credit card or debit card information for making the payment directly to the payment recipient (IRS, in this example). Note that for reconciliation, the tax authority (payment recipient) requires integration for the electronic filing process and the credit card bulk filer process. If there is an intermediary, it must submit a batch payment file in order for the tax authority to reconcile taxpayer data to the bulk payment amount. In order to add other electronic payment methods (other than credit or debit card), the tax authority must make payment file modifications for each request. This adds development, testing, and costs for the tax authority, and thus, may prevent other forms of electronic payments from being accepted, including credit cards in some cases.

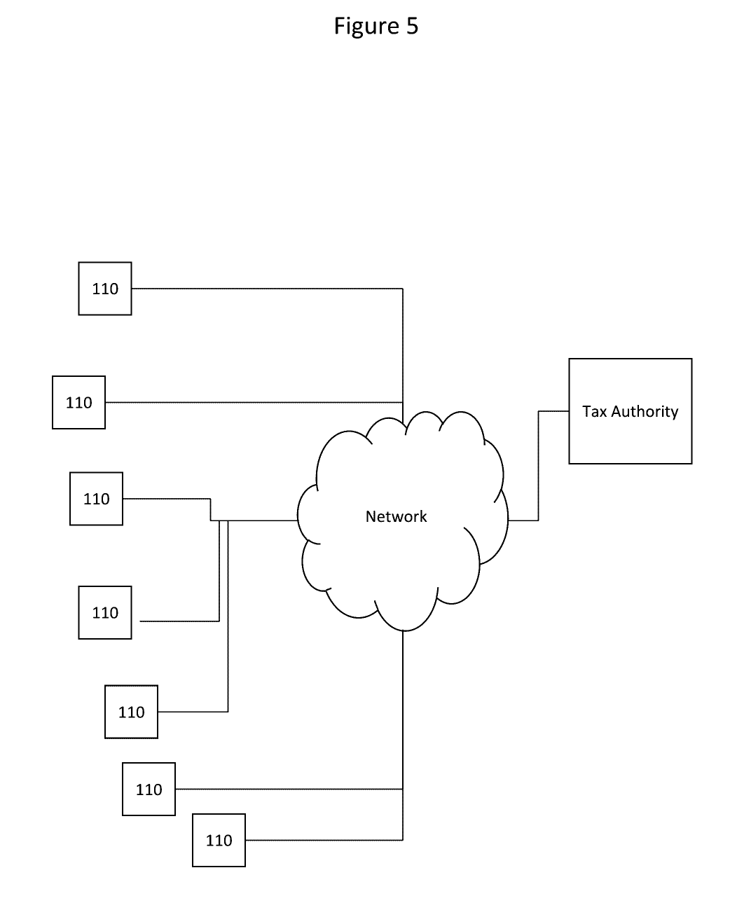

FIG. 5 is a schematic diagram showing a multiplicity of dedicated devices or terminals and networked connection for making the payments directly to the government by individuals and/or taxpayer entities represented by individuals using the devices. FIG. 5 illustrates configurations for the example of making a tax payment. Significantly, the government payment recipient does not require or accept a tax filing document at the time of receipt and acceptance of the electronic payment.

With the present invention methods, individuals are able to make electronic payments through any of the dedicated devices associated with the network for making secure payments directly to the government using a credit card or debit card, and by providing a unique taxpayer identification.

The taxpayer may use any of the dedicated devices or remote terminals or kiosks, and is not required to submit payments through the same dedicated device as with prior payments being submitted. Multiple payments for individual accounts with corresponding unique taxpayer identifications may be involved, wherein the tax payment is submitted directly for each entity by an authorized individual with a corresponding authorized credit card or debit card.

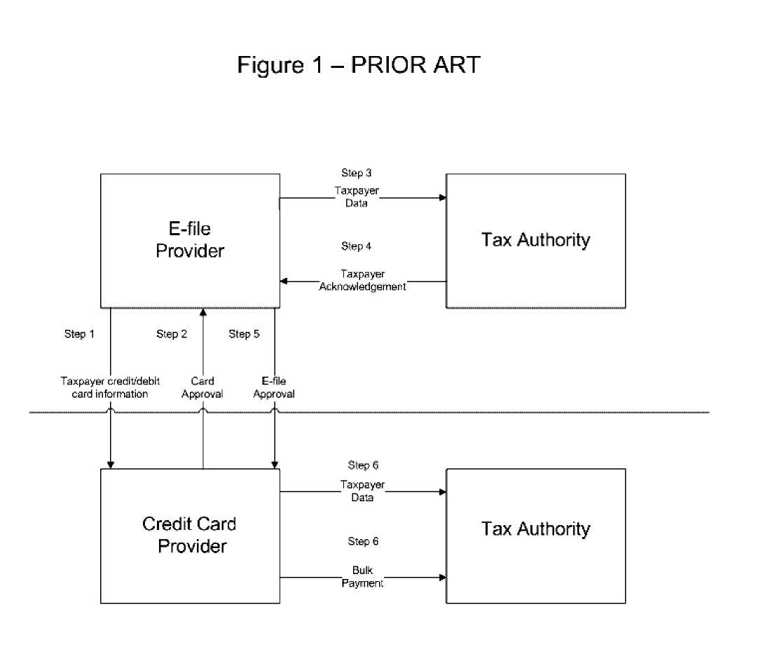

By contrast to the present invention, as illustrated by the PRIOR ART FIG. 1 flow diagram, it is known for individuals such as individual tax payers to make electronic filing of forms including payments. However, these transactions associated with the electronic filing and payment requires the government agency to collect funds from each individual by electronically debiting bank accounts individually or debit the intermediary account once for a batch of individual payments. It is a longstanding and unmet need that individual taxpayers cannot make credit card or debit card payments directly to the government via a dedicated device without coupling the payment to a tax filing or tax document submissions at the same time. Thus, the present invention solves the problems of the prior art by providing a dedicated device securely networked with government entities or agencies payment receiving systems that function to allow individual taxpayers to make a tax payment electronically without submitting a tax document or tax filing with it simultaneously.

The present invention provides for a technology supporting methods to facilitate electronic credit card and debit card payments to be made to the IRS or other government agency directly through such a freestanding, dedicated device or terminal, such as a POS device or kiosk that requires only the unique taxpayer identification and a credit card or debit card information that that taxpayer is authorized to use for making the payment. By way of example but not limitation, the network may be limited to IRS networks for making secure transmissions between the over 400 offices distributed throughout the US and the IRS central system or server(s) and the devices may be located at those offices. However, the devices may also be connected via more open networks while providing for secure payment transmissions using the credit card or debit card information and the unique taxpayer identification, all without coupling the payment with a tax filing or any tax document submission at the time of payment.

The present invention provides a method of completing electronic payments from individuals' and business' credit, debit, prepaid, ATM card, or other electronic payment methods, and combinations thereof, hereinafter defined and referred to as individually and collectively as electronic payments, to a taxing authority such as the IRS or state government, via any of the dedicated device(s) without submitting tax documents therewith. Preferably, immediate credit for the payment is provided by the government receiving entity for the tax payment made from the device, and the device provides an output or visual indicator of the confirmation of the successful payment and credit therefor.

Additionally, the present invention provides methods that facilitate individualized electronic payments to be made to the IRS, state tax departments, government agencies, and the like.

The present invention and preferred embodiments supporting best mode of application thereof as set forth in the foregoing, are supplied as examples and not intended to limit the scope of the invention thereto. By way of example and not limitation, applicable areas for the systems and methods of the present invention include the following: the public sector or government entities where individual taxpayer electronic payment is not available; the Federal government (e.g., individual income taxes, business taxes); state governments (e.g., individual income taxes, business taxes, sales and use tax, corporate filings, business licenses, other fees or licenses, etc.); local government (e.g., taxes, permits, court fees and fines, citations, etc. and combinations thereof.

With regard to federal and state income taxes, for example, the government will accept payment directly through the systems and methods of the present invention without validation of payment owed or tax filing documentation supporting the same. Since the government does not have confirmation of how much is owed for taxes at all times, for example with estimated quarterly taxes, the present invention provides that a taxpayer can provide for payment toward taxes owed without filing a return therewith.

Regarding the example of property taxes, the present invention provides for automated integrated remote payment of taxes directly—via check, credit card, etc. and received a notation automatically and immediately noted as paid, and the payment is made via the dedicated device (for example but not limitation, POS credit card system) integrated with government payment tax system, so that the system automatically updates payment records at the time the electronic payment is provided to indicate that they payment is received.

Notably, under the present invention an intermediary is operable to facilitate electronic payments to a government entity or any other entity. Types of payments include, but are not limited to, taxes, citations, court fees and fines, tuition, school fees, child support payments, utility payments, rent, assessments, HOA fees, insurance payments, healthcare-related payments, and more. In one embodiment, the present invention provides integrated online payment services for payees, including merchants, government entities, and utilities. The integrated payment services provide payors immediate confirmation that the electronic payment is authorized and completed. Preferably, the integrated payment services are provided by an application program interface (API). The API provides payees the ability to process credit, debit, electronic check, mobile wallet (ex: Visa Checkout, MasterPass, Android pay, Amex Express Checkout, and Apple Pay), and/or electronic currency (ex: Bitcoin) payments. The payment date of the payment is the date the payment was authorized by the payor. Real-time payment confirmations or rejections are provided by the intermediary. Thus, with the present invention, there is no delay in the payment date due to the wait for authorization as in the prior art.

Notably, the present invention is inextricably tied to computer technology because systems and methods of the present invention utilize devices connected over a network to accept and process payments in real-time, wherein the payments are associated with electronic credit cards, debit cards, or any electronic accounts such as electronic wallets or cryptocurrencies, decentralized digital currencies, or electronic currencies including Bitcoin, Ven, and/or Utoken. Electronic credit card-based transactions, debit card-based transactions, or transactions using any electronic accounts could not have been performed before the Internet. Furthermore, these transactions are not merely taking a concept known from the pre-Internet world or the pre-computer world with the requirement to perform the transactions over the Internet or over a computer network. Rather, these transactions require technology specific to the Internet or computer networks, and could not be performed in a pre-Internet or pre-computer technology world.

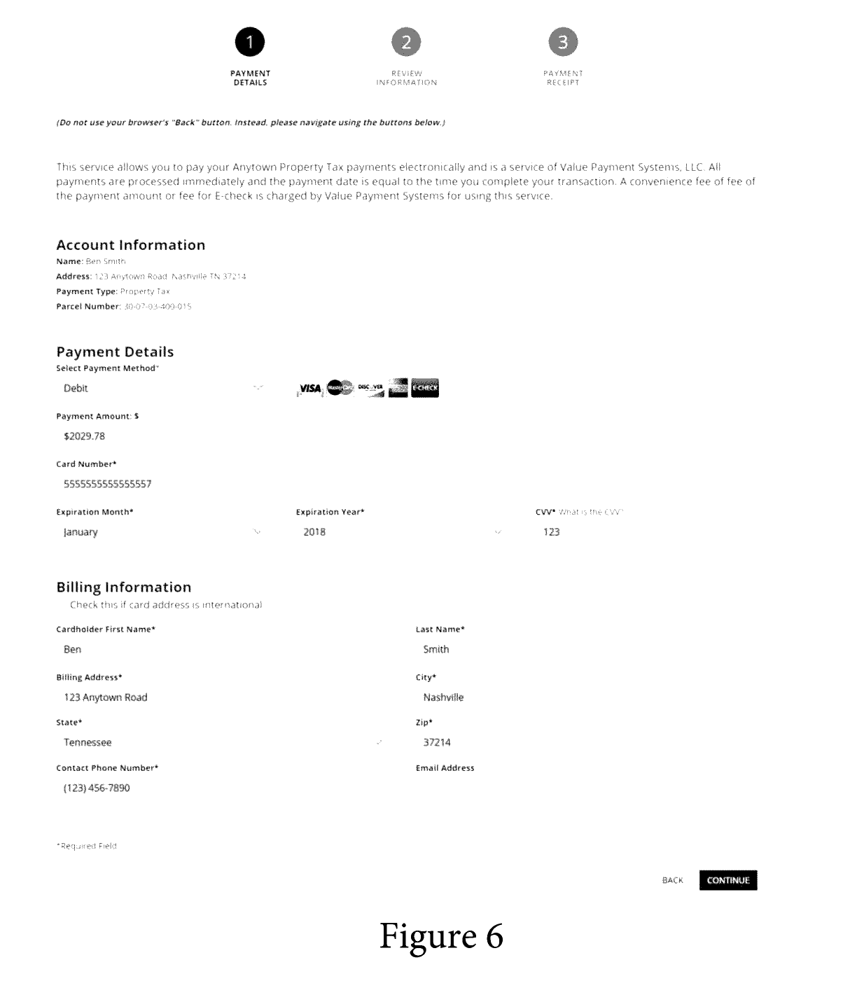

FIG. 6 is a screenshot of a graphical user interface (GUI) presented to a payor for entering information for making a payment to a payee via an intermediary. Advantageously, the GUI is displayed on a dedicated device or on any electronic device, including but not limited to a mobile phone, a cell phone, a smart phone, a laptop, a computer, a personal digital assistant (PDA), a tablet, or any other electronic device. A payor enters payment details, including a payment method, a payment amount, a card number or account number, an expiration month, an expiration year, a CVV, and billing information. Notably, for government payments, no more identifying information is needed, including but not limited to tax documentation, ticket information, property information, sales and use tax information, corporate filing information, business license information, permit information, court fees information, fine information, citation information, or information for any other fees, licenses, etc. Once the payor has entered the relevant information, the payor continues with the payment process via a “CONTINUE” button to review the information.

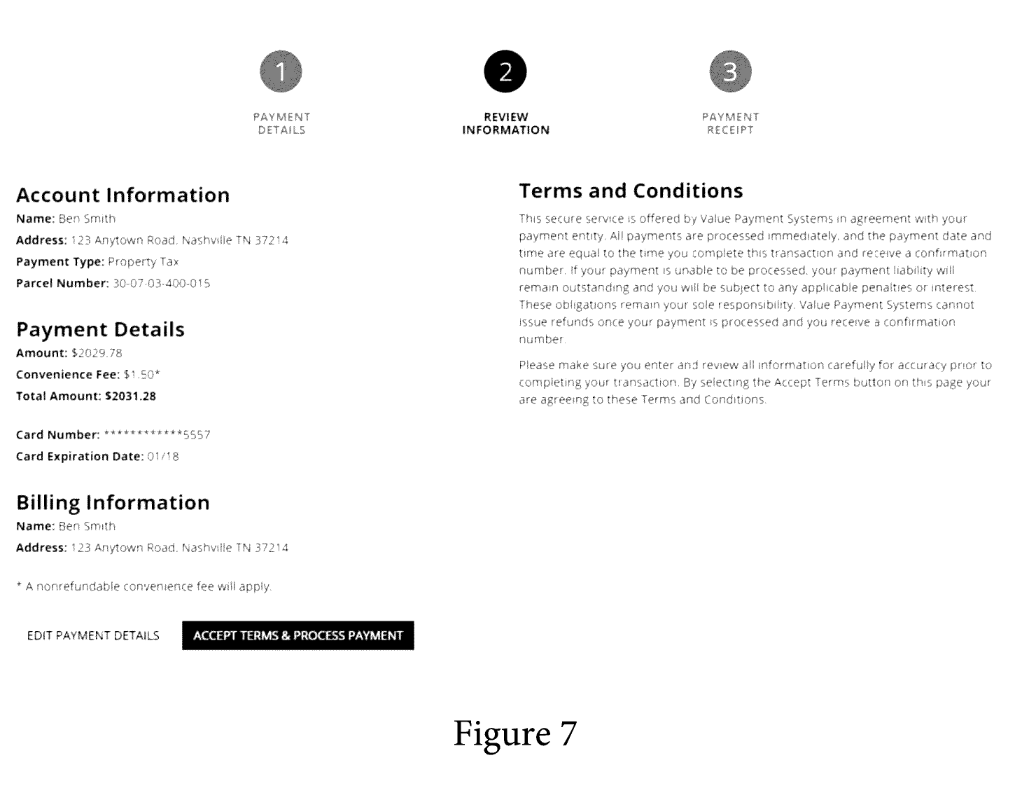

FIG. 7 is a screenshot of a graphical user interface (GUI) presented to a payor for reviewing information entered for making a payment to a payee via an intermediary. The GUI provides the account information, payment details, billing information, and terms and conditions. A convenience fee is displayed separately under the payment details section. Terms and conditions are also displayed. The payor edits the payment details or accepts the terms and instructs the intermediary to process the payment via an “ACCEPT TERMS & PROCESS PAYMENT” button.

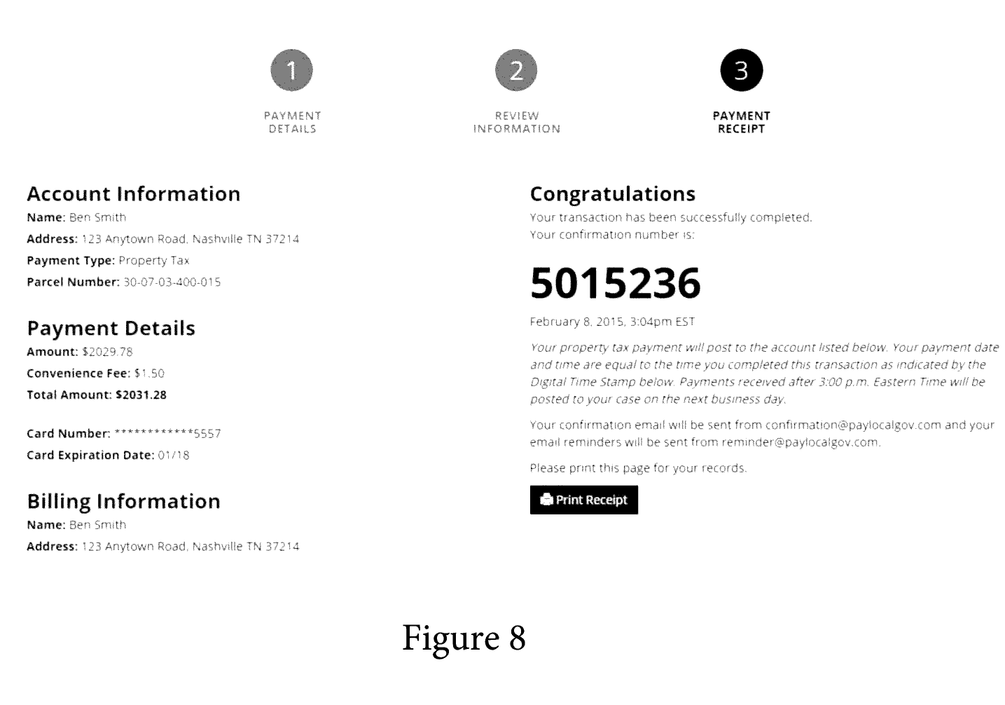

FIG. 8 is a screenshot of a graphical user interface (GUI) presented to a payor detailing the payment receipt for a payment made to a payee via an intermediary. The GUI provides the account information, payment details, billing information, and confirmation information, including a confirmation number and a date of payment. A “Print Receipt” button allows the payor to print a receipt for the payment.

The present invention advantageously provides for split settlement, with the gateway processing transactions through the appropriate financial institution and settling directly from the settlement financial institution to the payee's account. By settling directly to the payee's account, the intermediary does not receive any principal and only receives the convenience fee. The intermediary provides a settlement file in a desired format requested by the payee which matches the monies deposited on a daily basis. The intermediary also provides a detailed deposit report that matches the settlement file and monies deposited. A real-time reporting suite for retrieving, reviewing, printing, and downloading transaction and settlement data is also provided by the intermediary.

Communication under the methods and systems of the present invention is preferably performed via HTTPS POSTs. To implement the payment services of the present invention, two URLs are provided by or for the payee. One URL is utilized by the intermediary to post payment information of the payor and the other URL is used to redirect the payor after completion of a payment. Two URLs are also provided by or for the intermediary, with one of the URLs being for the payee to post payment information and the other URL being for the payee to redirect the payor to a payment information page.

According to one method of the present invention, the process for a third party facilitating a payment transaction includes the following steps: a payee collects and/or displays information about a payor with an amount due; the payor agrees to pay the amount due; the payee submits payor information and a unique RequestID to the intermediary; the intermediary returns a TransactionID to the payee; the payee saves the TransactionID; the payee redirects to an intermediary payment page with the TransactionID; the intermediary reads the TransactionID and gets transaction information; the payor enters payment information, acknowledges and agrees to the convenience fee amount; the intermediary submits the authorization/capture request for both the amount due and convenience fee; upon completion of the transaction, the intermediary web service returns the TransactionID, confirmation number, approval indicator, and last 4 digits of card to the payee and redirects the payor to the payee's receipt page using the RequestID; and the payee summarizes the transaction to the payor, optionally displaying the confirmation number, and the approval message. Thus, the intermediary collects the payment information, displays the convenience fee, gets acceptance on the payment terms and conditions, and authorizes and/or captures the payment and convenience fee. The aforementioned steps are preferably performed using HTTPS POST. The following list includes information sent to the intermediary via HTTPS POST along with the value, maximum size, and type of the information.

| Field Name | Value | Max Size | Type |
|---|---|---|---|
| PayeeID | PayeeID assigned to Payee by | 10 | N |
| | intermediary | | |
| RequestID | Payee-generated field identifying the | 32 | AN |
| | payment request. Must be unique for the | | |
| | Payee. | | |
| RetryCount | 0, 1, 2, 3 are the accepted values | 1 | N |
| | 0-first trial | | |
| | 1-2nd attempt | | |
| | 3-3rd attempt | | |
| | After 3rd attempt, the message an error | | |
| | message of 004 will be returned. | | |
| Username | Username associated with Payee | 10 | AN |
| | provided to intermediary by Payee prior | | |
| | to implementation | | |
| Password | Username associated with Payee | 10 | AN |
| | provided to intermediary by Payee prior | | |
| | to implementation | | |
| *PhoneNumber | Payer's phone number including the | 12 | N |
| | area code; without formatting | | |
| | characters. Acceptable formatting | | |
| | includes: | | |
| | NNNNNNNNNN (10 digits, no | | |
| | formatting marks) | | |
| | NNN-NNN-NNNN (12 digits, with | | |
| | formatting marks) | | |
| *EmailAddress | Payers email address for sending the | 75 | AN |
| | confirmation number (not required) | | |
| PaymentType | “AC” = Authorization/Capture | 2 | A |
| | “AO” = Auth Only | | |
| | “DR” = Deposit Request (Echeck Only) | | |
| Lineitem1Desc | Defines customer payee specific account | 50 | A |
| | information description; i.e. “map parcel | | |
| | number” | | |
| Lineitem1Detail | Defines customer payee specific account | 50 | AN |
| | (related to lineitem1Desc; i.e. | | |
| | “1234567” | | |
| Lineitem1Amount | Amount of line item 1; Implied decimal - | 8 | N |
| | for example $100.00 should be sent as | | |
| | 10000 (Minimum of 3 numbers; | | |
| | Maximum payment amount is | | |
| | $499,999.99. | | |
| *Lineitem2Desc | Defines customer payee specific account | 50 | A |
| | information description; i.e. “map parcel | | |
| | number” | | |
| *Lineitem2Detail | Defines customer payee specific account | 50 | AN |
| | (related to lineitem2Desc; i.e. | | |
| | “1234567” | | |
| *Lineitem2Amount | Amount of line item 2; Implied decimal - | 8 | N |
| | for example $100.00 should be sent as | | |
| | 10000 (Minimum of 3 numbers; | | |
| | Maximum payment amount is | | |
| | $499,999.99. | | |
| *Lineitem3Desc | Defines customer payee specific account | 50 | A |
| | information description; i.e. “map parcel | | |
| | number” | | |
| *Lineitem3Detail | Defines customer payee specific account | 50 | AN |
| | (related to lineitem3Desc; i.e. | | |
| | “1234567” | | |
| *Lineitem3Amount | Amount of line item 3; Implied decimal - | 8 | N |
| | for example $100.00 should be sent as | | |
| | 10000 (Minimum of 3 numbers; | | |
| | Maximum payment amount is | | |
| | $499,999.99. | | |
| *Lineitem4Desc | Defines customer payee specific account | 50 | A |
| | information description; i.e. “map parcel | | |
| | number” | | |
| *Lineitem4Detail | Defines customer payee specific account | 50 | AN |
| | (related to lineitem4Desc; i.e. | | |
| | “1234567” | | |
| *Lineitem4Amount | Amount of line item 4; Implied decimal - | 8 | N |
| | for example $100.00 should be sent as | | |
| | 10000 (Minimum of 3 numbers; | | |
| | Maximum payment amount is | | |
| | $499,999.99. | | |
| *Lineitem5Desc | Defines customer payee specific account | 50 | A |
| | information description; i.e. “map parcel | | |
| | number” | | |
| *Lineitem5Detail | Defines customer payee specific account | 50 | AN |
| | (related to Lineitem5Desc; i.e. | | |
| | “1234567” | | |
| *Lineitem5Amount | Amount of line item 4; Implied decimal - | 8 | N |
| | for example $100.00 should be sent as | | |
| | 10000 (Minimum of 3 numbers; | | |
| | Maximum payment amount is | | |
| | $499,999.99. | | |
| *Lineitem6Desc | Defines customer payee specific account | 50 | A |
| | information description; i.e. “map parcel | | |
| | number” | | |
| *Lineitem6Detail | Defines customer payee specific account | 50 | AN |
| | (related to Lineitem6Desc; i.e. | | |
| | “1234567” | | |
| *Lineitem6Amount | Amount of line item 4; Implied decimal - | 8 | N |
| | for example $100.00 should be sent as | | |
| | 10000 (Minimum of 3 numbers; | | |
| | Maximum payment amount is | | |
| | $499,999.99. | | |
| *Lineitem7Desc | Defines payer-specific account | 50 | A |
| | information description; i.e. “map parcel | | |
| | number” | | |
| *Lineitem7Detail | Defines payer-specific account (related | 50 | AN |
| | to lineitem7Desc; i.e. “1234567” | | |
| *Lineitem7Amount | Amount of line item 7; Implied decimal - | 8 | N |
| | for example $100.00 should be sent as | | |
| | 10000 (Minimum of 3 numbers; | | |
| | Maximum payment amount is | | |
| | $499,999.99 | | |
| *Lineitem8Amount | Amount of line item 4; Implied decimal - | 8 | N |
| | for example $100.00 should be sent as | | |
| | 10000 (Minimum of 3 numbers; | | |
| | Maximum payment amount is | | |
| | $499,999.99. | | |
| *Lineitem9Desc | Defines customer payee specific account | 50 | A |
| | information description; i.e. “map parcel | | |
| | number” | | |
| *Lineitem9Detail | Defines customer payee specific account | 50 | AN |
| | (related to Lineitem9Desc; i.e. | | |
| | “1234567” | | |
| *Lineitem9Amount | Amount of line item 9; Implied decimal - | 8 | N |
| | for example $100.00 should be sent as | | |
| | 10000 (Minimum of 3 numbers; | | |
| | Maximum payment amount is | | |
| | $499,999.99. | | |
| *Lineitem10Desc | Defines customer payee specific account | 50 | A |
| | information description; i.e. “map parcel | | |
| | number” | | |
| *Lineitem10Detail | Defines customer payee specific account | 50 | AN |
| | (related to Lineitem10Desc; i.e. | | |
| | “1234567” | | |
| *Lineitem10Amount | Amount of line item 4; Implied decimal - | 8 | N |
| | for example $100.00 should be sent as | | |
| | 10000 (Minimum of 3 numbers; | | |
| | Maximum payment amount is | | |
| | $499,999.99. | | |
| *CDF1 | Payer defined field | 200 | AN |
| *CDF2 | Payer defined field | 200 | AN |
| *CDF3 | Payer defined field | 50 | AN |
| *CDF4 | Payer defined field | 50 | AN |
| *CDF5 | Payer defined field | 50 | AN |
| *CDF6 | Payer defined field | 50 | AN |
| *CDF7 | Payer defined field | 50 | AN |
| *CDF8 | Payer defined field | 50 | AN |
| *CDF9 | Payer defined field | 50 | AN |
| *CDF10 | Payer defined field | 50 | AN |
| *Location ID | Location ID | 50 | AN |
| *CardNumber | Card Number (16 or 15 digits) | 16 | N |
| * ConvenienceFee | The convenience fee calculated at the | 8 | N |
| | payee end. Implied decimal - for | | |
| | example $100.00 should be sent as | | |
| | 10000 (Minimum of 3 digits; leading | | |
| | zeros if necessary) | | |
| CardExp | Card Expiration Date (MM/YY) | 4 | N |
| *Cvv | Cvv Code (4 digit for Amex, 3 digit for | 3-4 | n |
| | other cards) | | |
| echeckAccountType | “C” for checking, commercial; “S” for | 1 | N |
| | Saving | | |
| echeckAccountNumber | (Minimum of 8 numbers) | 17 | N |
| echeckRoutingNumber | 9 Numbers | 9 | N |
| *City | Customer payor's city | 50 | AN |
| *Statecode | Customer payor's state | 50 | AN |
| *Country | Customer payor's country, for United | 150 | AN |
| | States, always pass US | | |
| *Zipcode | Customer payor's zipcode | 50 | AN |
| *PhoneNumber | Customer payor's phone number | 12 | N |
| | including the area code; without | | |
| | formatting characters. Acceptable | | |
| | formatting includes: | | |
| | NNNNNNNNNN (10 digits, no | | |
| | formatting marks) | | |
| | NNN-NNN-NNNN (12 digits, with | | |
| | formatting marks) | | |
| *EmailAddress | Customer payor's email address for | 75 | AN |
| | sending the confirmation number (not | | |
| | required) | | |
| *BackButtonURL | Payee URL to which the payor should | 100 | URL |
| | be redirected after pressing the back | | |
| | button | | |

The intermediary collects the information, displays the convenience fee, gets acceptance on the payment terms and conditions, and authorizes and/or captures the payment and convenience fee.

The intermediary's response to a payment request from the payee is sent back as a response to the originating HTTPS POST with the following information.

| | | Max/Field |
|---|---|---|
| Field Name | Description | Type |
| TransactionID | The intermediary identifier of the | 32 AN |
| | transaction | |
| RequestId | From the payment request; echoed Back | 32 AN |
| | in response | |
| RequestStatus | 000 - Valid, any other number indicates | 3 N |
| | error | |
| StatusMessage | Text that describes the status of the | 255 AN |
| | request | |

A Confirmation Number Response is an HTTPS POST to the payee after completion of transaction of both the payment amount and convenience fee with the following information.

| Field Name | Description | Max/Field Type |
|---|---|---|
| RequestID | The Request ID from the original request | 32 AN |
| TransactionID | The intermediary identifier for the | 32 AN |
| | transaction as defined above | |
| ConfirmNumber | Customer payor confirmation number (7-10 | 7-10 N |
| | unique numbers) | |
| Last4Card | Last 4 of customers card (last 4 ssn if | 4 N |
| | BML is accepted) | |
| CardType | VI, MC, AX, DI, BL, S for savings and C | 2 A |
| | for checking of Echeck | |
| ApprovalStatus | 000 - Approved, other values indicate | 3 N |
| | error | |
| ApprovalText | Text that details the value in | 255 AN |
| | ApprovalStatus (e.g., APPROVED) | |
| BillingName | The cardholder name - We will return | AN |
| | this only if we are doing the AVS check | |
| BillingAddress | The cardholder address - We will return | AN |
| | this only if we are doing the AVS check | |
| *BillingCountry | 000 - Approved, other values indicate | 3 N |
| | error | |
| PaymentMode | C, D, E | 2 A |
| | C for Credit card | |
| | D for Debit card | |
| | E for Echeck | |
| Channel | PHONE (from mobile phone) | 2 A |
| | WEB (from desktop) | |
| PaidAmount | Amount Paid. This is in implied decimal | 2 A |
| ConvenienceFeeCharged | The Convenience fee that was charged | 8 N |
| | (in addition to the total payment amount) | |
| | (includes decimal, e.g. | |
| | “ConvenienceFeeCharged = 1.95” | |
| ApprovalText | Text that details the value in | 255 AN |
| | ApprovalStatus (e.g., APPROVED) | |
| BillingName | The account holder/card holder name | 100 A |
| BillingAddress | The account holder/card holder address | 300 A |
| PhoneNumber | The account holder/card holder phone | 20 AN |
| | number | |
| Email | The account holder/card holder email | 300 A |

A Confirmation Number Acknowledgement is sent to the intermediary in response to the Confirmation Number Response with the following information:

| | | Max/Field |
|---|---|---|
| Field Name | Description | Type |
| ConfAcknowledge | Yes = “1” | 1 N |
| TransactionID | The intermediary identifier for the | 32 AN |
| | transaction as defined above | |
| Username | Username associated with Partner | 10 AN |
| | provided to VPS by Partner prior to | |
| | implementation | |
| Password | Username associated with Partner | 10 AN |
| | provided to VPS by Partner prior to | |
| | implementation | |

Upon a successful authorization/completion of the payment and convenience fee, the intermediary displays a receipt, redirect the payor to the payee's page and pass the confirmation number. If the payor provided an email address, the intermediary provides the payor a confirmation email.

A Response to a Request for Refund is sent with the following information:

| Field Name | Description | Max/Field Type |
|---|---|---|
| RequestID | The Request ID from the original request | 32 AN |
| Last4Card | Last 4 digits of payer's card (last 4 ssn if | 4 N |
| | BML is accepted) | |
| ApprovalStatus | 000 - Approved, other values indicate | 3 N |
| | error | |
| ApprovalText | Text that details the value in | 255 AN |
| | ApprovalStatus (e.g., APPROVED) | |
| PaymentAmountRefunded | Payment Amount Refunded - Implied | 8 N |
| | decimal | |
| ConvenienceFeeRefunded | Convenience Fee Refunded - Implied | 8 N |
| | decimal. Will be empty for partial | |
| | refunds. | |
| ConfirmNumber | Payer confirmation number (7 unique | 7 N |
| | numbers) | |
| Lineitem1Detail | Payer-specific account (related to | 50 AN |
| | lineitem1Desc; i.e. “1234567” | |

A refund acknowledgment is sent with the following information:

| | | Max/Field |
|---|---|---|
| Field Name | Description | Type |
| RequestID | The VPS identifier for the transaction as | 32 AN |
| | defined above | |
| ConfAcknowledge | Yes = “1” | 1 N |
| Username | Username associated with Partner | 10 AN |
| | provided to VPS by Partner prior to | |
| | implementation | |
| Password | Username associated with Partner | 10 AN |
| | provided to VPS by Partner prior to | |
| | implementation | |

A convenience fee calculator includes the following information

| | | Max/ |
|---|---|---|
| | | Field |
| Field Name | Description | Type |
| PartnerID | Partner ID assigned to Partner by VPS - | 10 |
| | Unique Per terminal | |
| EntityID | assigned to Partner by VPS - This will | 10 N |
| | be unique per paymenttype | |
| Username | Username associated with Partner | 10 AN |
| | provided to VPS by Partner prior to | |
| | implementation | |
| Password | Username associated with Partner | 10 AN |
| | provided to VPS by Partner prior to | |
| | implementation | |
| TotalPaymentAmount | Total Payment amount - Amount to be | 8 |
| | charged to cardholder (DO NOT | |
| | INCLUDE CONVENIENCE FEE); | |
| | Implied decimal - for example $100.00 | |
| | should be sent as 10000 (Minimum of 3 | |
| | digits; leading zeros if necessary. | |
| | Maximum payment amount is | |
| | $499,999.99 | |
| CardNumber | Card Number (16 for Visa, MC, Disc | 16 |
| | and 15 for American Express) - Pass | |
| | “0000000000000000” for echeck | |
| CardExp | Card Expiration Date (MM/YY) - Pass | 4 |
| | “0000” for echeck | |

A convenience fee calculator response includes the following information

| | | Max/Field |
|---|---|---|
| Field Name | Description | Type |
| PartnerID | Partner ID assigned to Partner by VPS | 10 |
| Last4Card | Last 4 digits of payer's card (last 4 ssn if | 4 N |
| | BML is accepted) | |
| CardType | VI, MC, AM, DI, EC | 2 A |
| Status | 000 - Approved, other values indicate | 3 N |
| | error | |
| StatusText | Text that details the value in | 255 AN |
| | ApprovalStatus (e.g., APPROVED) | |
| ConvenienceFee | The Convenience fee due, based on | 8 N |
| | payment type and TotalPaymentAmount | |
| | (includes decimal, e.g. | |
| | “ConvenienceFee = 1.95” | |

API responses from the intermediary are preferably in variable text format, with the responses able to be parsed in virtually all programming languages, including.NET, PHP, and JSON. A Successful Payment Response Example is as follows:

RequestID=2324edcsafaasdfaaffd&ConfirmNumber=1663411395&ApprovalStatus=000&ApprovalText=Request Valid&ConvenienceFeeCharged=1.95&Last4Card=0060&CardType=VI&DetailedErrorCode=000&PaymentMode=Debit

An Unsuccessful Payment Response Example is as follows: RequestID=2324edcsafaasdfaaffd&ConfirmNumber=&Last4Card=&CardType=&ApprovalStatus=402&ApprovalText=UserName not valid;Password not valid

Sample annotated code for a form post of all relevant information to the intermediary URL and the intermediary server responding synchronously to the form post with a HTTPS response including a transaction ID is as follows:

public void PostDataToURL( )

{

string sPostURL = string.Empty; //This is the url for formposting

//Test url for form posting

http://demo.valuepaymentsystems.com/Intermediarysubmit/IntermediarySubmit.aspx

string dataToPost = string.Empty; //This is the data for form posting

HttpWebResponse httpResponse = null;

StreamReader readStream = null;
string respString = string.Empty;
Stream stOut = null;
try
{

// Create the request back
HttpWebRequest httpReq =

(HttpWebRequest)WebRequest.Create(sPostURL);

httpReq.Method = “POST”;
httpReq.ContentType = “application/x-www-form-urlencoded”;
ASCIIEncoding encoding = new ASCIIEncoding( );
byte[ ] byte1 = encoding.GetBytes(dataToPost);
httpReq.ContentLength = byte1.Length;
httpReq.Timeout = 10000;
// write out the request
stOut = httpReq.GetRequestStream( );
stOut.Write(byte1, 0, byte1.Length);
stOut.Dispose( );
stOut = null;
// send the request and wait for the reply
httpResponse = (HttpWebResponse)httpReq.GetResponse( );
readStream = new StreamReader(httpResponse.GetResponseStream( ),

System.Text.Encoding.GetEncoding(“utf-8”));

respString = readStream.ReadToEnd( );

}
catch (Exception ex)
{...
}
finally
{

if (stOut != null)
{

stOut.Dispose( );
stOut = null;

}
if (readStream != null)
{

readStream.Dispose( );
readStream = null;

}
if (httpResponse != null)
{

httpResponse.Close( );
httpResponse = null;

}

}

//At this point respString will have the response from intermediary.
//Decode the response from intermediary. The response string has name value

pairs such as:

//TransactionID=12345678123456781234567812345678&RequestId=34624624

&RequestStatus=000&StatusMessage=Valid

//You have to extract the required information from the response from the

response string

string transactionID = string.Empty; //This will have the transactionid

returned

from intermediary:

string requestStatus = string.Empty;
string[ ] nameValues = respString.Split(‘&’);
try

{

foreach (string item in nameValues)
{

string[ ] values = item.Split(‘=’);
if (values[0].Contains(“TransactionID”))
{

transactionID = values[0];

}

if (values[0].Contains(“RequestStatus”))
{

requestStatus = values[0];

}

//Split and get other values , StatusMessage .

..

}

}
catch (Exception exp)
{

//

}

}

The payee is redirected to the intermediary website using the received transaction ID upon detection of a valid status. Sample code for this step is as follows:

If(requestStatus == “000”) //Redirect only if the status is valid.
{
Response.Redirect(“devel.intermediaryenv.com/apipayment/Payment/CurrentSess

ion/ TID “);

}

The payee makes a payment at the intermediary hosted website. Once the transaction is complete, the intermediary automatically form posts the transaction response to ConfirmationPostURL that the payee gave the intermediary when the payee form posted the request.

Sample code to read the data that the intermediary form posted in C# is as follows:

object objValue = Request.Form[“REQUESTID”]; //Read all

values in the same way

string Requestid = string.empty;
if (objValue != null)
{
string value = objValue.ToString( );
Requestid = Server.UrlDecode(value);
}

The intermediary receives a response for the form post that the intermediary performed to the payee's ConfirmationPostURL. A preferred embodiment includes putting a literal on the payee's form and once the payee has completed processing (i.e. reading and logging the transaction result), assigning a value of TransactionID=value&ConfAcknowledge=1 to that literal. The intermediary searches for Transaction ID and ConfAcknowledge in the response and logs that value. At the end of the day, if the intermediary has not received an acknowledgement from the payee, the intermediary will form post the transaction results to the payee's confirmation post URL. Preferably, the payee form posts the acknowledgment using a message with the format

RequestID=VALUE&ConfAcknowledge=VALUE
&Username=VALUE&Password=VALUE.

A table of exemplary processing responses is as follows:

| ApprovalStatus | Category | ApprovalText |
|---|---|---|
| 000 | APPROVAL | Approved |
| 001 | ABANDONED | (Not |
| | | Applicable) |
| 002 | GENERIC ERROR | Processing error |
| 003 | VERBAL AUTH | Need verbal |
| | | auth |
| 004 | Error on the 4th trial | An error |
| | | occurred. Please |
| | | contact our |
| | | customer |
| | | support at |
| | | XXX-XXX- |
| | | XXXX |
| 005-099 | DECLINED | Declined |

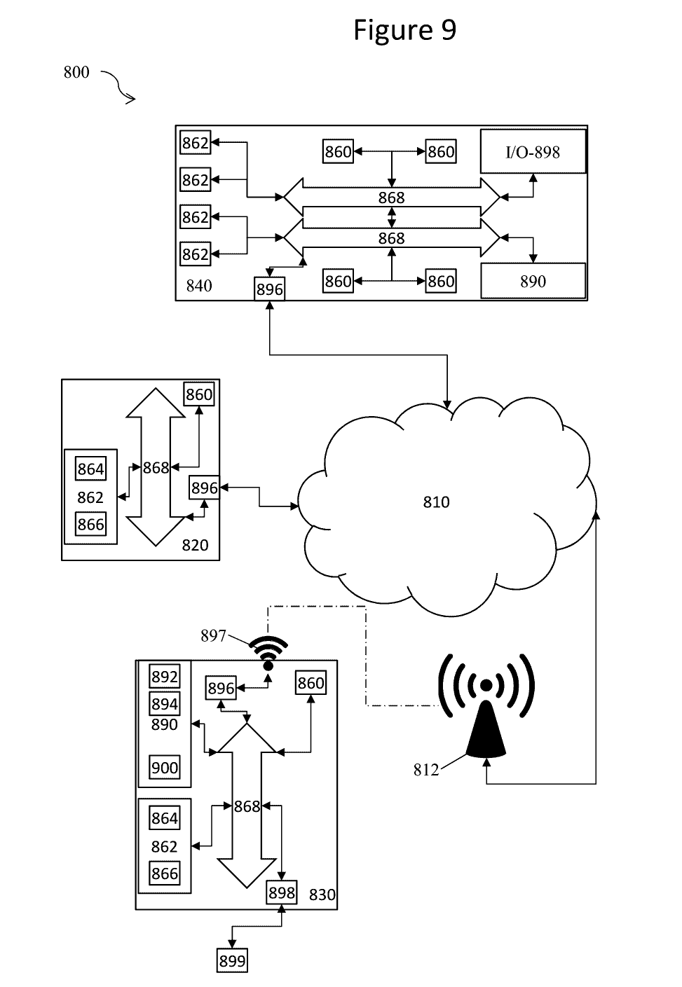

FIG. 9 is a schematic diagram of an embodiment of the invention illustrating a computer system used for communicating the above described information and code over a network, with the computer system being generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 may house an operating system 872, memory 874, and programs 876.

In one embodiment of the invention, the system 800 includes a cloud-based network 810 for distributed communication via a wireless communication antenna 812 and processing by at least one mobile communication computing device 830. In another embodiment of the invention, the system 800 is a virtualized computing system capable of executing any or all aspects of software and/or application components presented herein on the computing devices 820, 830, 840. In certain aspects, the computer system 800 may be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of digital computers 820, 840, 850 and mobile devices 830, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in this document

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 may additionally include components such as a storage device 890 for storing the operating system 892 and one or more application programs 894, a network interface unit 896, and/or an input/output controller 898. Each of the components may be coupled to each other through at least one bus 868. The input/output controller 898 may receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 9, multiple processors 860 and/or multiple buses 868 may be used, as appropriate, along with multiple memories 862 of multiple types (e.g., a combination of a DSP and a microprocessor, a plurality of microprocessors, one or more microprocessors in conjunction with a DSP core).

Also, multiple computing devices may be connected, with each device providing portions of the necessary operations (e.g., a server bank, a group of blade servers, or a multi-processor system). Alternatively, some steps or methods may be performed by circuitry that is specific to a given function.

According to various embodiments, the computer system 800 may operate in a networked environment using logical connections to local and/or remote computing devices 820, 830, 840, 850 through a network 810. A computing device 830 may connect to a network 810 through a network interface unit 896 connected to a bus 868. Computing devices may communicate communication media through wired networks, direct-wired connections or wirelessly, such as acoustic, RF, or infrared, through an antenna 897 in communication with the network antenna 812 and the network interface unit 896, which may include digital signal processing circuitry when necessary. The network interface unit 896 may provide for communications under various modes or protocols.

In one or more exemplary aspects, the instructions may be implemented in hardware, software, firmware, or any combinations thereof. A computer readable medium may provide volatile or non-volatile storage for one or more sets of instructions, such as operating systems, data structures, program modules, applications, or other data embodying any one or more of the methodologies or functions described herein. The computer readable medium may include the memory 862, the processor 860, and/or the storage media 890 and may be a single medium or multiple media (e.g., a centralized or distributed computer system) that store the one or more sets of instructions 900. Non-transitory computer readable media includes all computer readable media, with the sole exception being a transitory, propagating signal per se. The instructions 900 may further be transmitted or received over the network 810 via the network interface unit 896 as communication media, which may include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

It is also contemplated that the computer system 800 may not include all of the components shown in FIG. 9, may include other components that are not explicitly shown in FIG. 9, or may utilize an architecture completely different than that shown in FIG. 9. The various illustrative logical blocks, modules, elements, circuits, and algorithms described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention as set forth in the claims.

1. A method for processing payments to an entity electronically over a network-based system comprising:
a payor computer receiving payment information including a payor payment account for an amount due via a graphical user interface (GUI);
the payor computer receiving via the GUI an acceptance of a payment including the amount due and a convenience fee amount;
an intermediary computer submitting an authorization request for the payment;
upon receipt of an authorization message authorizing the payment, the intermediary computer processing the payment;
the intermediary computer providing a real-time payment confirmation to the payor computer, wherein the real-time payment confirmation is displayed on the GUI; and
the intermediary computer providing the real-time payment confirmation to the payee computer;
wherein the payee computer accepts the amount due from the payor computer without validation of payment owed; and
the payee computer automatically updating payment records at the time the amount due is paid to indicate that the amount due has been received.

2. The method of claim 1, wherein the payee computer is a government entity computer securely networked with the intermediary computer, further comprising the payor computer receiving a unique taxpayer identification number via the GUI, wherein the unique taxpayer identification number is a government-assigned taxpayer identification, and wherein no tax filing documentation is submitted via the payor computer.

3. The method of claim 1, wherein the intermediary computer providing the real-time payment confirmation to the payee computer includes the intermediary computer performing a form post to a confirmation post URL hosted by the payee computer.

4. The method of claim 3, wherein the intermediary computer performing the form post to the confirmation post URL hosted by the payee computer includes posting a literal on the form post, and upon the payee computer updating the payment records, the intermediary computer assigning a value of 1 to the literal.

5. The method of claim 1, wherein the steps of the intermediary computer submitting the authorization request for the payment, the intermediary computer providing the real-time payment confirmation to the payor computer, and the intermediary computer providing the real-time payment confirmation to the payee computer are performed using HTTPS POST.

6. The method of claim 1, wherein the convenience fee amount is transferred from an institution associated with the payor payment account to an account associated with the intermediary computer and wherein the amount due is transferred from the institution associated with the payor account to an account associated with the payee computer.

7. The method of claim 1, wherein the real-time payment confirmation includes a unique transaction identifier (ID), a confirmation number, and 4 digits of the payor payment account.

8. A method for processing payments to an entity electronically over a network-based system comprising:
a payee computer submitting payor information and a unique request identifier (ID) to an intermediary computer;
the intermediary computer returning a unique transaction ID to the payee computer;
the payee computer saving the unique transaction ID;
the payee computer directing a payor computer to an intermediary payment page hosted by the intermediary computer using the unique transaction ID, the payment page including a graphical user interface (GUI);
the intermediary computer reading the unique transaction ID to obtain transaction information;
the payor computer receiving payment information including a payor payment account for an amount due via the GUI;
the payor computer receiving an acceptance of a payment including the amount due and a convenience fee amount displayed on the GUI;
the intermediary computer submitting an authorization request for the payment;
upon receipt of an authorization message authorizing the payment, the intermediary computer processing the payment;
the intermediary computer providing a real-time payment confirmation to the payee computer by creating a payee receipt page;
the payee computer automatically updating payment records at the time the amount due is paid to indicate that the amount due has been received; and
the intermediary computer redirecting the payor computer to the payee receipt page using the unique request ID.

9. The method of claim 8, wherein the payee computer is a government entity computer securely networked with the intermediary computer, further comprising the payor computer receiving a unique taxpayer identification number via the GUI, wherein the unique taxpayer identification number is a government-assigned taxpayer identification, and wherein no tax filing documentation is submitted via the payor computer.

10. The method of claim 8, wherein the intermediary computer providing the real-time payment confirmation to the payee includes the intermediary computer performing a form post to a confirmation post URL hosted by the payee computer.

11. The method of claim 10, wherein the intermediary computer performing the form post to the confirmation post URL hosted by the payee computer includes posting a literal on the form post, and upon the payee computer updating the payment records, the intermediary computer assigning a value of 1 to the literal.

12. The method of claim 8, wherein the steps of the payee computer submitting payor information and the unique request ID to the intermediary computer, the intermediary computer returning the unique transaction ID to the payee computer, and the intermediary computer submitting the authorization request for the payment are performed using HTTPS POST.

13. The method of claim 8, wherein the convenience fee amount is transferred from an institution associated with the payor payment account to an account associated with the intermediary computer and wherein the amount due is transferred from the institution associated with the payor account to an account associated with the payee computer.

14. The method of claim 8, wherein the payee receipt page includes the unique transaction ID, a confirmation number, an approval indicator, and 4 digits of the payor payment account to the payee computer.

15. A system for processing payments to an entity electronically over a network-based system comprising:
a payee computer connected over a network to a payor computer and an intermediary computer, wherein the intermediary computer is connected over the network to the payor computer;
wherein the intermediary computer is operable to receive payor information and a unique request identifier (ID) from the payee computer;
wherein the intermediary computer is operable to return a unique transaction ID to the payee computer upon receiving the payor information and the unique request ID;
wherein the payee computer is operable to redirect the payor computer to an intermediary payment page hosted by the intermediary computer using the unique transaction ID;
wherein the intermediary computer is operable to read the unique transaction ID to obtain transaction information;
wherein the payor computer is operable to receive payment information including a payment account for an amount due via a graphical user interface (GUI);
wherein the payor computer is operable to receive through the GUI an acceptance of a convenience fee amount displayed on the GUI;
wherein the intermediary computer is operable to submit an authorization request for a payment including the amount due and the convenience fee;
wherein the intermediary computer is operable to process the payment;
wherein, upon receipt of an authorization message, the intermediary computer is operable to provide a real-time payment confirmation to the payee computer by creating a payee receipt page which includes the unique transaction ID, a confirmation number, an approval indicator, and four digits of the payment account to the payee computer;
wherein the payee computer is operable to update payment records in real-time; and
wherein the intermediary computer is operable to direct the payor computer to the payee receipt page using the unique request ID.

16. The system of claim 15, wherein the payee computer is a government entity computer securely networked with the intermediary computer, wherein the payor computer is operable to receive a unique taxpayer identification number via the GUI, wherein the unique taxpayer identification number is a government-assigned taxpayer identification, and wherein no tax filing documentation is submitted with the authorization request.

17. The system of claim 15, wherein the intermediary computer is operable to provide the real-time payment confirmation to the payee by performing a form post to a confirmation post URL hosted by the payee computer.

18. The system of claim 17, wherein the intermediary computer performing a form post to a confirmation post URL hosted by the payee computer includes posting a literal on the form post, and upon the payee computer updating the payment records, the intermediary computer assigning a value of 1 to the literal.

19. The system of claim 15, wherein the intermediary computer is operable to submit the authorization request for the payment via HTTPs POST.

20. The system of claim 15, wherein the convenience fee amount is transferred from an institution associated with the payor payment account to an account associated with the intermediary computer and wherein the amount due is transferred from the institution associated with the payor account to an account associated with the payee computer.
